(19) United States
(12) Patent Application Publication
(10) Pub. No.: US 2026/0067421 A1
(43) Pub. Date: Mar. 5, 2026

(54) FEATURE CACHE-BASED GENERATIVE VIDEO EDITING FOR DYNAMIC FRAME GENERATION

(71) Applicant: NVIDIA Corporation, Santa Clara, CA (US)

(72) Inventors: Mustafa MUNIR, Manor, TX (US); Sophia ZALEWSKI, Sunnyvale, CA (US); Shiqiu LIU, Santa Clara, CA (US); David TARJAN, Mountain View, CA (US); Anjul PATNEY, Redmond, WA (US)

(73) Assignee: NVIDIA Corporation, Santa Clara, CA (US)

(21) Appl. No.: 19/242,720

(22) Filed: Jun. 18, 2025

Related U.S. Application Data
(60) Provisional application No. 63/690,571, filed on Sep. 4, 2024.

(51) Int. Cl. H04N 7/01; G06T 7/20

(52) U.S. Cl. CPC H04N 7/0135; G06T 7/20

(57) ABSTRACT

Various examples, systems, and methods are disclosed relating to feature cache-based generative video editing for dynamic frame generation. A system can apply a first frame as input to a machine learning model to retrieve, from the machine learning model, a first embedding of the first frame. The system can store the first embedding in a cache, wherein the cache includes a second embedding of a second frame. The system can generate a third frame using the machine learning model based at least on the cache, wherein the third frame is associated with the first frame. The system can output the third frame to a video stream comprising a fourth frame.

### CROSS-REFERENCE TO RELATED APPLICATIONS

The present application claims the benefit of and priority to U.S. Provisional Patent Application No. 63/690,571, filed Sep. 4, 2024, the disclosure of which is incorporated herein by reference in its entirety.

### BACKGROUND

Some systems can edit videos using diffusion-based models. These systems can generate edited images but lack the temporal consistency required of real-time video streaming scenarios, causing flickering and/or other unappealing visual effects. Other systems can produce temporally consistent video frames based on pre-computed inter-frame correspondences, but these systems process at high latencies and therefore are unable to perform real-time video editing tasks. Some systems generate edited video streams by relying on token merging techniques which discard fine-grained or motion-specific details, leading to a lack of temporal consistency across frames.

### SUMMARY

Systems and methods are disclosed related to feature cache-based generative video editing for dynamic frame generation. Systems and methods in accordance with the present disclosure can implement AI video generation models, such as diffusion models, that use a feature cache for storing useful video frame feature data to facilitate the video generation process. The feature cache can be used to selectively maintain information, relating to a scene for which to generate video, that relates to temporal considerations, while maintaining the capability of real-time or near real-time processing.

Conventional diffusion models, while effective, are slow due to their large size and the numerous iterations required to generate a single image (e.g., 30 to 50 iterations), making real-time application impractical. Additionally, these models lack temporal consistency, as they are designed for generating individual images (e.g., based on a text prompt) rather than producing a series of related images over time.

In contrast to conventional systems, such as those described above, systems and methods in accordance with the present disclosure can allow for real-time edited video generation with shorter frame generation time and/or more frames per second by conditioning a diffusion model to generate, from video input, one or more temporally consistent edited frames by querying the feature cache for relevant stored features. For example, the systems and methods herein can leverage caching mechanisms and temporal embeddings to facilitate the video generation process in real-time applications.

Real-time applications can include, but are not limited to, style transfer (e.g., converting an existing video style to claymation, pixel art, pencil sketch, anime, and/or other styles), image enhancement (e.g., include receiving a low-resolution video (e.g., a video lacking detail) and adding detail back to the video), and object replacement tasks (e.g., detecting an object in a video (e.g., a dog) and replacing the object with a different object (e.g., a cat)). In some examples, the systems and methods herein can edit the visual details indicating the weather in a video (e.g., rain) to instead indicate different weather (e.g., sunshine).

In some implementations, the techniques described herein relate to one or more processors including processing circuitry to apply a first frame as input to a machine learning model to retrieve, from the machine learning model, a first embedding of the first frame. The processing circuitry can store the first embedding in a cache, wherein the cache includes a second embedding of a second frame. The processing circuitry can generate a third frame using the machine learning model based at least on the cache, wherein the third frame is associated with the first frame. The processing circuitry can output the third frame to a video stream including a fourth frame.

In some implementations, the processing circuitry is to store the first embedding in a first slot in the cache. The processing circuitry can store the second embedding in a second slot in the cache. In some implementations, the first frame and the second frame are separated by an interval.

In some implementations, the processing circuitry is to interpolate a fifth frame based at least on the fourth frame and the third frame, wherein the fourth frame is previously generated. The processing circuitry can output the fifth frame to the video stream between the fourth frame and the third frame.

In some implementations, the processing circuitry is to, responsive to determining that a number of stored embeddings exceeds a cache capacity, remove a third embedding from the cache according to a corresponding weight.

In some implementations, the processing circuitry is to predict a fifth frame based at least on the third frame. The processing circuitry can store a third embedding of the fifth frame in the cache.

In some implementations, the processing circuitry is to assign, to at least one of the first embedding or the second embedding, a weight determined according to a duration of the corresponding embedding in the cache.

In some implementations, the fourth frame is associated with the second frame.

In some implementations, the fifth frame is predicted using optical flow.

In some implementations, the techniques described herein relate to a method. The method can include applying a first frame as input to a machine learning model to retrieve, from the machine learning model, a first embedding of the first frame. The method can include storing the first embedding in a first slot in a cache, wherein the cache includes a second embedding of a second frame in a second slot in the cache. The method can include generating a third frame using the machine learning model based at least on the cache, wherein the third frame is associated with the first frame. The method can include outputting the generated third frame to a video stream including a generated fourth frame.

In some implementations, the method can include interpolating a fifth frame based at least on the generated fourth frame and the generated third frame; and outputting the interpolated fifth frame to the video stream between the generated fourth frame and the generated third frame.

In some implementations, the method can include determining an optical flow between the third frame and a fifth frame, wherein the fifth frame includes raw image data; predicting a sixth frame based at least on the optical flow; and storing a third embedding of the sixth frame in the cache.

In some implementations, the method can include assigning a first weight to the first embedding, the first weight determined according to a corresponding duration of the first embedding in the cache.

In some implementations, the first embedding of the generated fourth frame is associated with a third embedding of the second frame.

In some implementations, the method can include extending a self-attention layer of the machine learning model based at least on the cache.

In some implementations, the method can include linearly decreasing a second weight of the second embedding based at least on storing the first embedding in the cache.

In some implementations, the method can include, responsive to determining that a number of stored embeddings exceeds a cache capacity, removing the second embedding from the cache, based at least on the second weight.

In some aspects, the techniques described herein relate to a system including one or more processors to apply a first frame as input to a machine learning model to retrieve, from the machine learning model, a first embedding of the first frame. The one or more processors can store the first embedding in a first slot in a cache, wherein the cache includes a second embedding of a second frame in a second slot in the cache. The one or more processors can generate a third frame using the machine learning model based at least on the cache, wherein the third frame is associated with the first frame. The one or more processors can output the third frame to a video stream including a generated fourth frame.

### BRIEF DESCRIPTION OF THE DRAWINGS

The present systems and methods for feature cache-based generative video editing for dynamic frame generation are described in detail below with reference to the attached drawing figures, wherein:

FIG. 1 is a block diagram of an example generative model system, in accordance with implementing some embodiments of the present disclosure;

FIG. 2 is a block diagram of an example cache-based generative video editing system, in accordance with implementing some embodiments of the present disclosure;

FIG. 3 is a flow diagram of an example of a method for generating a frame using a cache, in accordance with implementing some embodiments of the present disclosure;

FIG. 4 is a block diagram of an example content streaming system suitable for use in implementing some embodiments of the present disclosure;

FIG. 5 is a block diagram of an example computing device suitable for use in implementing at least some embodiments of the present disclosure;

FIG. 6 is a block diagram of an example data center suitable for use in implementing at least some embodiments of the present disclosure;

FIG. 7 is a block diagram of an example generative model that includes a transformer encoder-decoder suitable for use in implementing at least some embodiments of the present disclosure; and

FIG. 8 is a block diagram of an example generative model that includes a decoder-only transformer architecture suitable for use in implementing at least some embodiments of the present disclosure.

### DETAILED DESCRIPTION

Systems and methods are disclosed related to feature cache-based generative video editing for dynamic frame generation. For example, the systems and methods herein can allow for real-time edited video generation with shorter frame generation time and/or more frames per second.

Some systems can edit videos using diffusion-based models. These systems can generate edited images but lack the temporal consistency required of real-time video streaming scenarios such as gaming, causing flickering and/or other unappealing visual effects. Other systems are able to produce temporally consistent video frames based on pre-computed inter-frame correspondences, but these systems process at high latencies and therefore are unable to perform real-time video editing tasks.

Some systems generate edited video streams by relying on token merging techniques, such as merging archived features from past frames with incoming frame features to create a compact feature bank. This merging process, however, often discards fine-grained or motion-specific details, leading to a lack of temporal consistency across frames.

In contrast to conventional systems, such as those described above, systems and methods in accordance with the present disclosure can allow for real-time edited video generation with shorter frame generation time and/or more frames per second by conditioning a diffusion model to generate, from video input, one or more temporally consistent edited frames by querying the feature cache for relevant stored features. In some implementations, the system can include a feature cache that includes features of previous frames of a video input stream. The system can extract features from a new input frame. The system can generate one or more temporal embeddings based at least on the extracted features. The system can store temporal embeddings in the feature cache. By querying the feature cache for relevant stored features, the system can condition a diffusion model to generate one or more temporally consistent edited frames and can output the frames to or as a video stream.

In some implementations, the system can maintain global consistency (e.g., coherence between frames in multiple-frame output) by storing features from a plurality of frames. The system can maintain temporal consistency over long sequences by storing frame features at an interval, such as every fourth frame, and removing a past feature from the feature cache responsive to the cache size exceeding a capacity and/or temporal threshold. The past feature can be selected for removal responsive to the past feature indicating a longest duration in the feature cache. The system can decrease processing time by skipping every other input frame (or every few input frames) for editing. The system can generate one or more frames in place of skipped frames by performing frame interpolation between edited frames (e.g., using a Real-time Intermediate Flow Estimation (RIFE) technique). The system can generate predicted frames based at least on the edited and/or interpolated frames. The system can generate the predicted frames using an optical flow technique. The system can store one or more embeddings of the predicted frame in the feature cache to maintain consistency between the current frame and the next input frame to be edited.

As used herein, the term “features” refers to numerical representations or descriptive attributes extracted from an input, such as an image, video frame, or a portion thereof, that capture key characteristics of the input. In the context of computer vision, features may include low-level visual patterns (e.g., edges, corners, texture), mid-level representations (e.g., object parts, semantic regions), or high-level abstract information (e.g., class-relevant representations). Features can be extracted using handcrafted techniques (e.g., SIFT, HOG) or learned representations generated by one or more neural network layers, such as convolutional layers in a convolutional neural network (CNN).

As used herein, the term “embeddings” refers to vectorized representations that encode semantic or contextual information about an input or portion thereof (keys, queries, and/or values). Embeddings can be derived from features by projecting the extracted features into a continuous vector space, often of lower dimensionality, using a learned transformation. Embeddings can be used to facilitate comparison, classification, retrieval, or other downstream processing tasks. In some implementations, embeddings may be generated using fully connected layers, pooling operations, and/or attention-based encoding mechanisms applied to the extracted features.

As used herein, “features” and “embeddings” may be used interchangeably where context permits, particularly when referring to intermediate representations output by a neural network. As used herein, the term “features” may generally refer to representations directly extracted from the input data (e.g., convolutional feature maps), while “embeddings” may refer to transformed or encoded versions of such features that are often used for downstream tasks or inter-component communication.

As used herein, the term “self-attention” refers to a mechanism by which each element of an input sequence (e.g., a sequence of features or embeddings) is processed in relation to every other element in the sequence to compute context-aware representations. In computer vision applications, self-attention allows a model to assign weights to different spatial locations in an image or different frames in a video, thereby enabling the model to selectively focus on relevant parts of the input.

In various implementations, self-attention may operate on features, embeddings, or both. For example, a vision transformer may apply self-attention to patch-wise embeddings derived from image features to compute a refined representation that captures global dependencies. Accordingly, features, embeddings, and self-attention may be employed in combination within a processing pipeline to enable tasks such as classification, detection, segmentation, and/or generation.

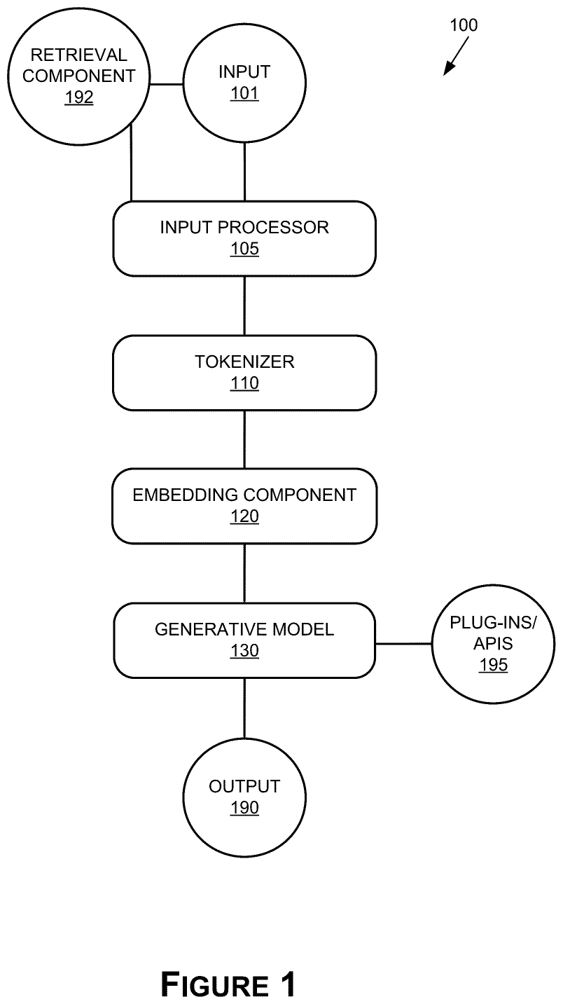

Referring to FIG. 1, FIG. 1 is a block diagram of an example generative model system 100. In the example illustrated in FIG. 1, the generative model system 100 includes an input processor 105, an embedding component 120, a retrieval component 192, plug-ins/APIs 195, and a generative model (LM) 130 (which may include a GAN, a VLM, a multi-modal LM, etc.).

The input processor 105 may receive input data 101, which may include image data, video data, and/or other types of visual or multimodal input data (e.g., sensor data, 3D models, CAD designs, USD scene graphs). The input processor 105 can resize the data to a standard size compatible with format of a corresponding input channel and/or can normalize pixel values to a common range (e.g., 0 to 1) to ensure a consistent representation. The embedding component 120 can encode the image data using any known technique (e.g., using one or more convolutional neural networks (CNNs) to extract visual features). In some implementations in which the input 101 includes audio data, the input processor 105 may resample an audio file to a consistent sampling rate for uniform processing, and the embedding component 120 may use any known technique to extract and encode audio features—such as in the form of a spectrogram (e.g., a mel-spectrogram). In some implementations in which the input 101 includes video data, the input processor 105 may extract frames and/or apply resizing to extracted frames. The embedding component 120 may extract features from the input 101, such as optical flow embeddings or video embeddings and/or may encode temporal information or sequences of frames. In some implementations in which the input 101 includes multi-modal data, the embedding component 120 may fuse representations of the different types of data (e.g., text, image, audio, USD, video, design, etc.) using techniques like early fusion (concatenation), late fusion (sequential processing), attention-based fusion (e.g., self-attention, cross-attention), etc. In sequential frame implementations (e.g., video), the embedding component 120 may also extract temporal features using optical flow, recurrent layers, and/or spatiotemporal convolutions. For multimodal inputs, fusion techniques (e.g., concatenation, attention-based alignment, or joint embedding spaces) may be used to unify visual and contextual inputs.

In some implementations, the retrieval component 192 may be used to retrieve grounding information to be used as part of the conditioning input to the generative model 130. For example, the retrieval component 192 may obtain textual, visual, or structured information from external data sources or knowledge bases (e.g., images, image-text pairs, visual tags, or descriptive labels) based on the context or intended transformation of the input image. Retrieved content may be embedded and supplied to the generative model 130 to inform or refine the denoising process. The retrieval component 192 may also access image libraries, prior embeddings, or external visual knowledge graphs to support frame generation tasks.

In some implementations, the plugin or API-based architecture 195 may be implemented, allowing the system to interact with external services such as CAD tools, asset databases, cloud-based vision processing APIs, or knowledge retrieval engines. For example, if the input 101 involves transforming a 3D design into a stylized rendering, the plug-in/API 195 may supply environmental lighting data or texture references from a material database.

The generative model 130 and/or other components of the generative model system 100 may use different types of neural network architectures depending on the implementation. For example, transformer-based architectures such as those used in models like GPT may be implemented, and may include self-attention mechanisms that weigh the importance of different features in the input and/or feedforward networks that process the output of the self-attention layers, applying non-linear transformations to the input representations and/or extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, the embedding component 120 can apply an encoded representation of the input 101 to the generative model 130. The generative model 130 can process the encoded representation of the input 101 to generate an output 190, which can include one or more final output images.

As described herein, in some implementations, the generative model 130 may be configured to access or use—or capable of accessing or using—plug-ins/APIs 195 (which may include one or more plug-ins, application programming interfaces (APIs), databases, data stores, repositories, etc.). For example, for certain tasks or operations that the generative model 130 is not ideally suited for, the model may have instructions (e.g., as a result of training, and/or based on instructions in a given prompt, such as those retrieved using the retrieval component 192) to access one or more plug-ins/APIs 195 (e.g., 3^{rd} party plugins) for help in processing the current input. As such, the model(s) may not only rely on its own knowledge from training on a large dataset(s) and/or from data retrieved using the retrieval component 192, but also on the expertise or optimized nature of one or more external resources—such as the plug-ins/APIs 195.

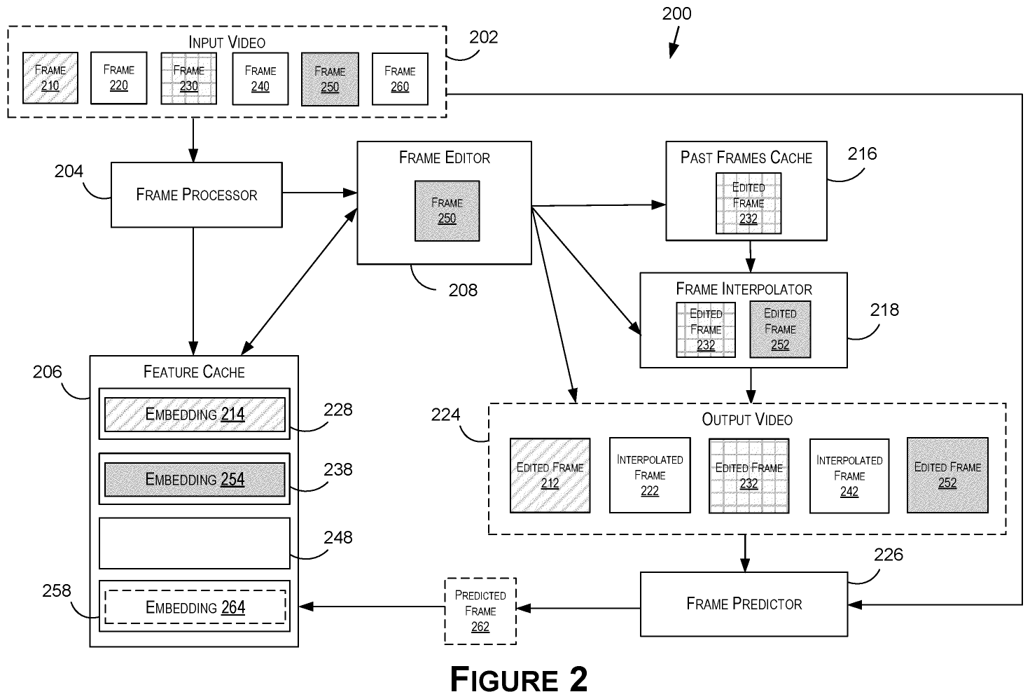

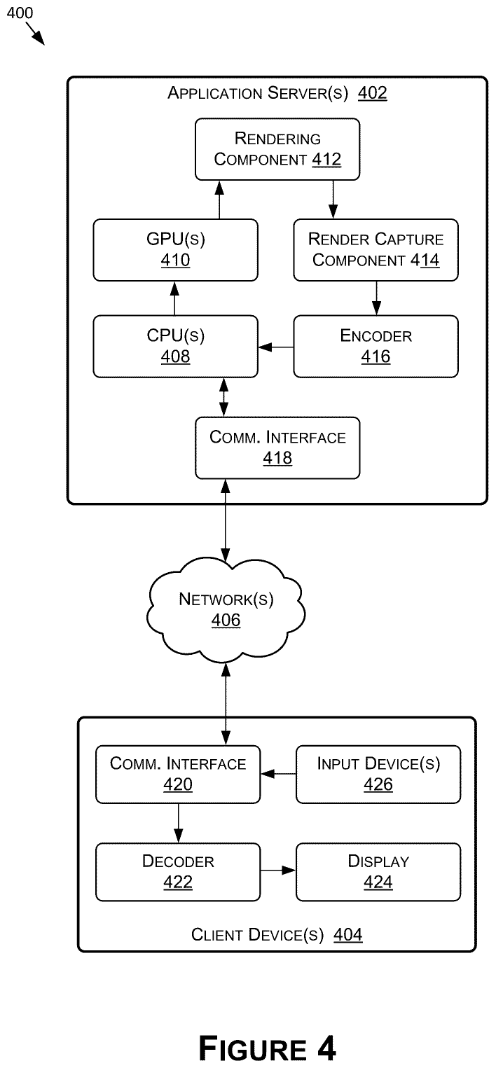

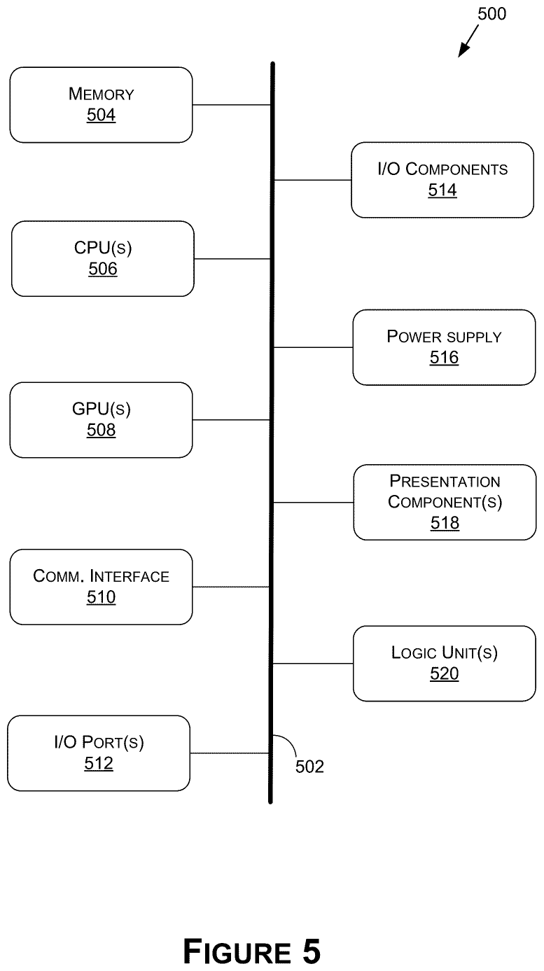

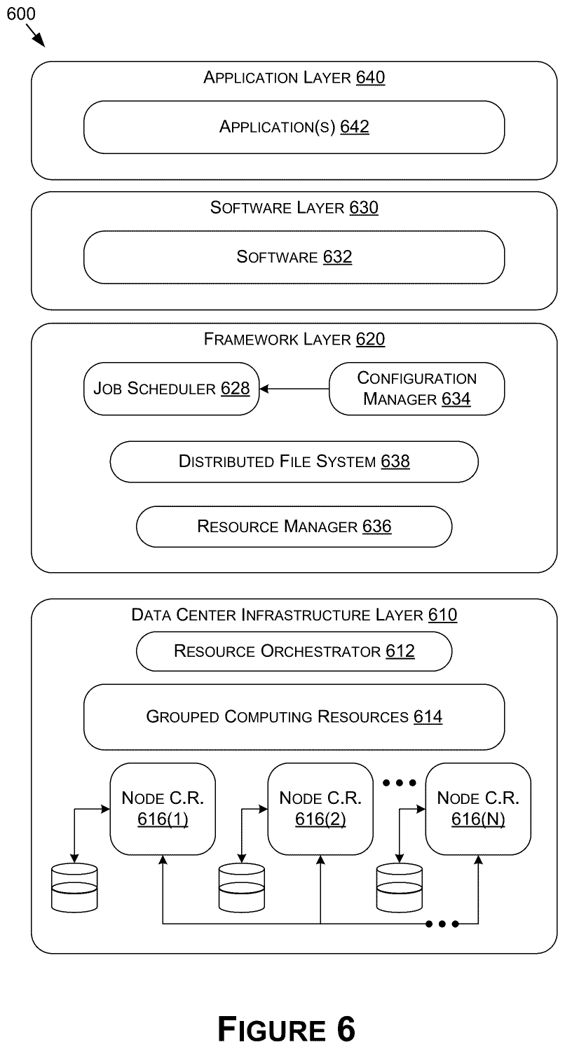

With reference to FIG. 2, FIG. 2 shows an example system for feature cache-based generative video editing, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some implementations, the system and methods described herein may be implemented using one or more generative language models (e.g., as described in FIGS. 1, 7, and 8), one or more computing devices or components thereof (e.g., as described in FIGS. 4 and 5), and/or one or more data centers or components thereof (e.g., as described in FIG. 6).

The system 200 can process an input video 202. The input video 202 can include one or more input frames 210, 220, 230, 240, 250, and 260. The input video 202 can be a video stream. The input video 202 can be a video file (e.g., .mp4, .mov). The input video 202 can include real-time input frames.

The system 200 can include at least one frame processor 204 to process the input video 202. The frame processor 204 can include or be implemented by a central processing unit (CPU), a graphics processing unit (GPU), a digital signal processor (DSP), or any combination thereof. The frame processor 204 can process the one or more input frames of the input video 202. The frame processor 204 can process frames in a streaming fashion, supporting unlimited input frames. The frame processor 204 can select frames to edit. For example, the frame processor 204 can edit every other frame such that the remaining frames are skipped from editing (e.g., selecting frames 210, 230, and/or 250 to edit). The interval at which the frame processor 204 selects frames can be predetermined, e.g., based at least on a target frame generation speed and/or a target frame resolution. The frame processor 204 can provide, as input, selected frames into frame editor 208.

The system 200 can include at least one feature cache 206. The feature cache 206 can store (e.g., maintain, archive) features from the one or more input frames 202. The feature cache 206 can condition a diffusion-based model (e.g., frame editor 208) to generate one or more temporally consistent edited frames. The feature cache 206 can store one or more features (e.g., embeddings 214, 254, 264) of input video 202. The feature cache 206 can include one or more slots 248 for storing the one or more features, such that features (e.g., temporal and/or spatial embeddings) are stored together in the feature cache 206 (e.g., for the system 200 to access quickly) while maintaining distinction between features corresponding to respective frames of the one or more input frames 202 through each of separate slots 248. A capacity of the feature cache 206 can be predetermined, the capacity representing a number of slots 248 of the feature cache 206 that may be available to store features, based at least on available computer resources, a target frame generation speed, and/or a target frame resolution. The system 200 can assign respective indices to each of the slots 248. A capacity of the feature cache 206 can correspond to the maximum number of features that can be stored, e.g., input frames for which features can be stored. The feature cache 206 can store features for a capacity of 5, 8, 10, or a different number of frames. The feature cache 206 may not be at capacity (e.g., one or more slots 248 is empty), such as when the system 200 receives the first few frames as input.

The frame processor 204 can extract features from one or more input frames. The frame processor 204 can include or be coupled with the embedding component 120 of FIG. 1. The frame processor 204 can process the one or more input frames by extracting visual features using one or more neural network layers, such as convolutional layers, fully connected layers, residual blocks, and/or attention-based mechanisms. The one or more neural network layers can be the same or different from one or more neural network layers of a diffusion-based model of frame editor 208. The extracted features may correspond to localized spatial patterns within the input frame and may be represented as multi-dimensional tensors (e.g., having a shape corresponding to a number of channels, height, and width). The frame processor 204 can generate one or more embeddings 214, 254, and/or 264 by applying dimensionality reduction operations, such as global average pooling, flattening, and/or projection through a fully connected layer, to convert the extracted features (e.g., feature maps) into the embeddings (e.g., dense, fixed-length vector representations). The embeddings can include projected keys, queries, and/or values of the input frame. The frame processor 204 can store the embeddings 214, 254, and/or 264 in the feature cache 206 at an interval. For example, the feature cache can store embeddings of a frame at every N frames (e.g., N=2, N=4, N=6, or any interval).

The feature cache 206 can assign one or more weights to the embeddings of the feature cache to prioritize the features from more recent frames. The feature cache 206 can linearly decrease the weight of (e.g., downweight) older frames' features within the feature cache 206. Based at least on the frame processor 204 adding information to the feature cache 206, the feature cache 206 can apply the temporal embedding weight, denoted as TEⱼ, where j corresponds to an index of the temporal embedding (e.g., the frame's features) in the feature cache 206. For example, the feature cache 206 can determine the weight for the temporal embedding TEⱼ for older frames' features as:

$${TE}_{j} = \frac{1.}{1. + \frac{A}{S}}$$

where A is the “age” of the frames' features, starting from an “age” of 0 for the current frame, and S is the scaling factor that adjusts the impact of the temporal embedding. The feature cache 206 can apply the temporal embedding weight to an embedding, e.g., by summing and/or concatenating a vector representation of the temporal weighting (e.g., a temporal encoding). The feature cache 206 can apply the temporal embedding weight for an embedding by multiplying the embedding with the temporal embedding weight. In this example, the maximum value of the temporal embedding weight is 1.0 (e.g., high importance) for the current frames' features in the feature cache 206. By applying temporal embedding weights to the features in the feature cache, the system 200 can reduce the importance of older frames' features at self-attention, thereby enhancing local frame consistency while maintaining global frame consistency.

The feature cache 206 may be at capacity, e.g., such that each of slots 248 is filled. The feature cache 206 can remove one or more embeddings to prevent exceeding the capacity of the cache. For example, the feature cache 206 can remove frames from the cache once the cache size exceeds a capacity of M frames (e.g., M=8), such that the feature cache 206 stores embeddings for up to 8 frames, the embeddings for each frame stored in a respective slot. Based at least on receiving a new input frame, the feature cache 206 can remove one or more embeddings for a frame according to an associated weight assigned to the one or more embeddings. For example, the feature cache 206 can remove the features according to the lowest associated weighting (e.g., T Eⱼ=0.01). This can result in an empty slot (e.g., such that there are 7 slots still full). The feature cache 206 can linearly decrease the assigned weights of the one or more stored embeddings, indicating an increase duration of each of the one or more remaining embeddings in the cache. The feature cache 206 can store one or more embeddings of the new input frame in the emptied slot.

The system 200 can include at least one frame editor 208 to receive one or more frames as input and generate one or more edited frames. The frame editor 208 can include one or more generative models (e.g., diffusion-based model). The generative model can include encoder and/or decoder blocks. The blocks can include a residual convolutional unit and/or a transformer module. The transformer module can include a self-attention layer, a cross-attention layer, and/or a feedforward network. Unlike systems that apply batch-based methods (e.g., denoising multiple frames at the same time, inflating the self-attention layer to cross-frame attention, and/or employing token merging), the system 200 can extend the self-attention to feature cache 206, incorporating information from past frames and/or a predicted next frame, as described further herein. For example, the frame editor 208 can receive an input frame 250 (e.g., of a realistic object, person, animal, and/or environment) and apply a diffusion-based generative model to transform the frame 250, for example, into a claymation-style rendering. The model can iteratively denoise a latent representation of the frame using encoder and/or decoder blocks. The encoder block can extract hierarchical features using residual convolutional units and/or transformer modules comprising self-attention and/or cross-attention layers. The frame editor 208 can extend the self-attention layer with one or more embeddings of the feature cache 206 (e.g., embeddings 214 and/or 254) by manipulating (e.g., concatenating, summing, and/or multiplying) one or more embeddings 254 (e.g., keys, queries, and/or values obtained from intermediate transformer module input) of the input frame 250 with one or more stored embeddings 214 (e.g., keys, queries, and/or values) from the feature cache 206, enabling the frame editor 208 to generate a temporally consistent output frame 252. The one or more stored embeddings 214 can be temporally weighted embeddings (e.g., temporal embeddings) such that more recent temporal embeddings of the feature cache 206 with higher weights have greater impact at self-attention compared to older temporal embeddings of the feature cache 206 with lower weights. Conditioning data (e.g., a style prompt) may be incorporated via cross-attention layers. The decoder block can reconstruct an edited (e.g., claymation-stylized) frame as noise is progressively removed. The frame editor 208 can store one or more edited frames in a past frames cache 216. The frame editor 208 can provide the edited frame as input into the frame interpolator 218. The frame editor 208 can output the edited frame 252 to the output video 224.

The system 200 can include at least one past frames cache 216 to store one or more previously edited frames. The past frames cache 216 can allow for the system 200 to skip frames (e.g., every other frame) when performing diffusion-based editing. The system 200 can generate one or more interpolated frames between edited frames using the past frames cache 216, reducing the time required to generate video output and/or decreasing flickering of output video 224. The interpolated frames (e.g., interpolated frames 222 and 242) can correspond, respectively, to the skipped frames (e.g., frames 220 and 240). The past frames cache 216 can include a predetermined number of slots (e.g., one available slot). The past frames cache 216 can store, for example, a most recently previously edited frame 232. A frame interpolator 218 can retrieve the most recently edited frame 232. The frame interpolator 218 can perform an interpolation of a new frame 242 between the frame 232 and a current edited frame 252.

The system 200 can include at least one frame interpolator 218 to generate one or more frames, e.g., interpolated frames 222 and/or 242, using an interpolation technique. The frame interpolator 218 can include one or more neural networks, e.g., one or more neural network architectures, such as convolutional neural networks (CNNs), residual networks (ResNets), U-Net architectures, transformer-based models, and/or recurrent neural networks (RNNs). The frame interpolator 218 can apply one or more interpolation techniques (e.g., RIFE, Recurrent All-Pairs Field Transforms (RAFT), FlowNet, and/or accelerated frame interpolation methods such as those used in NVIDIA Deep Learning Frame Generation (DLFG) and/or NVIDIA Deep Learning Performance Preset (DLPP)) to generate one or more frames based at least on edited frames from the past frames cache 216. Compared to systems that edit every frame, the systems and methods herein can interpolate frames between edited frames while maintaining spatial, temporal, and/or contextual frame information, thereby increasing the number of frames per second (fps) while reducing computational resources (e.g., memory).

For example, the frame interpolator 218 can retrieve a current edited frame 252 and a previously edited frame 232. The frame interpolator 218 can retrieve the frames 252 and 232 from the frame editor 208 and the past frames cache 216, respectively. The frame interpolator 218 can apply at least one neural network (e.g., IFNet) to estimate an intermediate flow corresponding to the temporal midpoint between the two frames. The intermediate flow can be used to warp the first and second frames toward the intermediate timestamp (e.g., move corresponding pixels from the input frames to the same location in a latent intermediate frame). A fusion module can combine the warped frames to synthesize the interpolated frame (e.g., combine pixels from two input frames).

The system 200 can generate output video 224. The output video 224 can include one or more edited frames. The output video 224 can include one or more interpolated frames. In some examples, every other frame of the output video is an edited frame, such as edited frames 212, 232, and 252. In these examples, the remaining frames are interpolated frames, such as interpolated frames 222 and 242.

In some examples, the interpolated frames of output video 224 correspond to the locations of frames skipped by the frame processor 204 for editing. For example, in an input of three frames 210, 220, and 230, the frame processor 204 can provide the first frame 210 and the third frame 230 as input to the frame editor 208 and skip the second frame. In this example, although the second frame 220 is skipped from editing, one or more embeddings of the second frame may be extracted by the frame processor 204 and stored in the feature cache 206. The edited first frame 212 can correspond to the first frame 210. The edited third frame 232 can correspond to the third frame 230. The intermediate timestamp associated with the interpolated frame 222 can be associated with a timestamp corresponding to the skipped frame 220.

The system 200 can include at least one frame predictor 226 to predict one or more frames. The frame predictor can include one or more generative models. The frame predictor 226 can apply an optical flow technique to predict an optical flow based at least on one or more frames of output video 224 and a next unprocessed frame 260. The frame predictor 226 can generate a predicted frame 262 based at least on the predicted motion. The frame predictor 226 can store one or more embeddings of predicted frame 262 in the feature cache 206 such that the system 200 can apply information from past, present, and future frames from the feature cache 206 for added temporal coherence in frame generation tasks.

For example, to determine the motion (e.g., optical flow) Fᵢ between two reference frames representing the current frame Cᵢ (e.g., edited frame 252) and the next frame to be processed Nᵢ (e.g., unprocessed input frame 260), the frame predictor 226 can transform the current frame Cᵢ and the next frame to be processed Nᵢ into grayscale frames GCᵢ and GNᵢ, wherein:

$${GC}_{i} = RGB 2 Gray ( {C}_{i} )$$

$${GN}_{i} = RGB 2 Gray ( {N}_{i} )$$

To determine the optical flow Fᵢ, the frame predictor 226 can compute the pixel-wise motion (e.g., a field of displacement vectors) between GCᵢ and GNᵢ. The frame predictor 226 can use the optical flow Fᵢ to warp GCᵢ to a predicted next frame NPᵢ (e.g., predicted frame 262). For example:

$${NP}_{i} = {GC}_{i} ( x + {F}_{i} ( x ) )$$

wherein x represents the coordinates of the frame GCᵢ, and Fᵢ(x) represents the optical flow vector at the coordinates of frame GCᵢ. The frame predictor 226 can append the features of predicted frame NPᵢ to feature cache 206, incorporating information from predictive future frames for temporal consistency in frame generation (e.g., by frame editor 208).

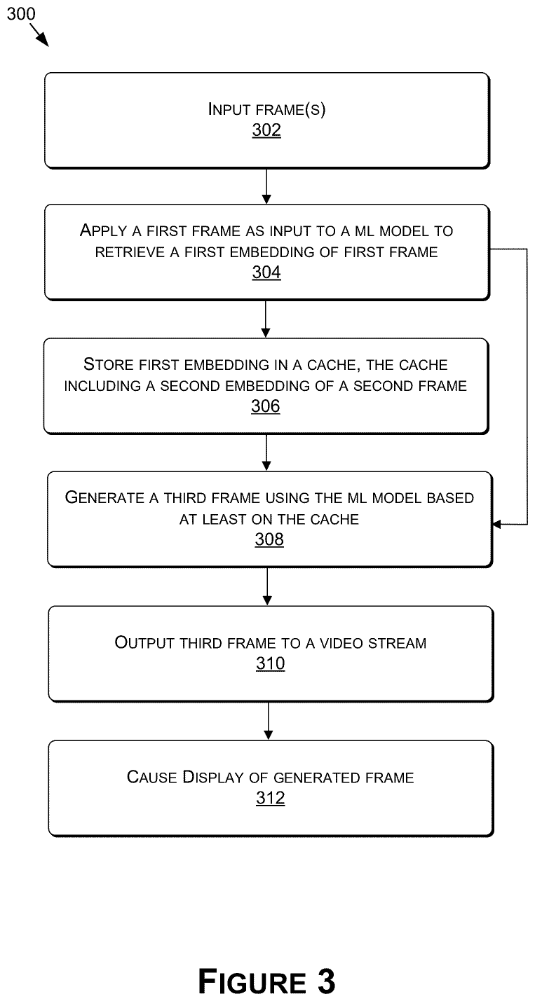

Now referring to FIG. 3, FIG. 3 is a flow diagram of an example of a method 300 for generating a frame using a cache. Each block of method 300, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 300 is described, by way of example, with respect to the system of FIG. 2. However, this method may additionally or alternatively be executed by any one system, or any combination of systems, including, but not limited to, those described herein.

The method 300, at block 302, can include receiving, as input, one or more input frames, such as from a live-stream video source, supporting unlimited input frames. The one or more input frames can be received via I/O components 514 of computing device 500 (FIG. 5). The method 300 can include processing the one or more input frames in real-time.

The method 300, at block 304, can include applying a first frame of the one or more input frames as input to a machine learning model to retrieve, from the machine learning model, a first embedding of the first frame. The machine learning model can include one or more neural networks (e.g., CNNs). The one or more neural networks can include one or more neural network layers, such as convolutional layers, residual blocks, and/or attention-based mechanisms. The method 300 at block 304 can include preprocessing the first frame (e.g., raw input data), such as resizing the first frame to a target resolution, converting the color space (e.g., RGB to YUV), and/or normalizing pixel values to a predefined range (e.g., 0 to 1). The method 300 at block 304 can include using one or more convolutional layers to extract low-level features of the first frame, such as edges, corners, and/or texture. The method 300 at block 304 can include representing the low-level features as one or more feature maps. The method 300 at block 304 can include applying non-linear activation functions (e.g., ReLU) and/or normalization operations (e.g., batch normalization, layer normalization) to the feature map to stabilize feature distributions of the feature map. The method 300 at block 304 can include refining the feature map using one or more residual blocks to extract mid-level and/or high-level features. The method 300 at block 304 can include applying one or more attention-based mechanisms, such as self-attention, to refine the feature maps by capturing long-range spatial dependencies. The method 300 at block 304 can include performing downsampling operations (e.g., max pooling and/or strided convolution) on the one or more feature maps to reduce a resolution of the one or more feature maps, e.g., to produce one or more embeddings including a first embedding (e.g., a fixed-length vector embedding). In some implementations, method 300 at block 304 can include dividing the one or more feature maps into spatial patches and projecting each patch into a lower-dimensional vector space to generate the one or more embeddings. The one or more embeddings can encode semantic, spatial, temporal and/or contextual information. The method 300 at block 304 can include generating a temporal encoding indicative of the first frame's timestep in the one or more input frames. The method 300 at block 304 can include adding the temporal encoding to the first embedding, such as by summing and/or concatenating the first embedding with the temporal encoding. The resulting embedding can serve as a compact, high-level representation of the input frame for use in downstream processing tasks.

The method 300, at block 306, can include storing the first embedding in a cache, wherein the cache includes a second embedding of a second frame. The method 300 at block 306 can include storing frames at an interval. For example, the method 300 at block 306 can include storing the first embedding in the cache based at least on the second frame being separated from the first frame by the interval. The interval can be any number of frame separation (e.g., 2 frames, 4 frames, 5 frames). For example, for an interval of 4 frames, the second frame occurring at timestep 1, wherein timestep 1 corresponds to a first-occurring frame in the sequence of frames and wherein the second embedding of the second frame is stored in the cache, the first frame occurring at timestamp 5, wherein timestamp 5 corresponds to the fifth-occurring frame in the sequence of frames, the method 300 at block 306 can include storing the first embedding of the first frame in the cache. The method 300 at block 306 can include assigning a first weight to the first embedding and a second weight to the second embedding, the first weight and the second weight determined according to a corresponding duration of the respective embedding in the cache.

The method 300, at block 308, can include generating a third frame using the machine learning model based at least on the cache, wherein the third frame is associated with the first frame. The model can include a neural network architecture (e.g., U-Net). The method 300 at block 308 can include processing a current frame, (e.g., the first frame) using the machine learning model. The machine learning model can include encoder and decoder blocks. Each encoder or decoder block can include a residual convolutional unit and/or a transformer module. The transformer module can include a self-attention layer, a cross-attention layer, and/or a feedforward network. The method 300 at block 308 can include extending the self-attention layer of each transformer module to incorporate one or more embeddings from the cache. For example, the method 300 at block 308 can include concatenating one or more current embeddings of the current frame (e.g., the first embedding of the first frame) with those stored in the cache (e.g., the second embedding of the second frame), enabling the model to generate a third frame (e.g., an output frame). The generated third frame can thereby exhibit temporal and stylistic consistency with prior frames without requiring all frames to be processed simultaneously in a batch.

The method 300, at block 310, can include outputting the third frame to a video stream comprising a fourth frame. The fourth frame can be a frame previously generated by the machine learning model. The method 300 at block 310 can include generating a fifth frame based at least on the fourth frame and the third frame. The method 300 at block 310 can include performing an interpolation technique (e.g., RIFE, RAFT, FlowNet, DLFG and/or DLPP) to generate the fifth frame. The method 300 at block 310 can include outputting the fifth frame in between the fourth frame and the third frame such that the output video stream is temporally coherent.

The method 300, at block 312, can include providing the output video stream data for display on a display device. The method 300 at block 312 can include displaying the output video to a user. For example, the method 300 at block 312 can include, for a user wearing an augmented reality device directing a lens of the device towards the sky on a cloudy day, presenting a processed video stream of sunshine and a clear sky, maintaining temporal coherence and/or other contextual coherence.

### Example Content Streaming System

Now referring to FIG. 4, FIG. 4 is an example system diagram for a content streaming system 400, in accordance with some implementations of the present disclosure. FIG. 4 includes application server(s) 402 (which can include similar components, features, and/or functionality to the example computing device 500 of FIG. 5), client device(s) 404 (which can include similar components, features, and/or functionality to the example computing device 500 of FIG. 5), and network(s) 406 (which can be similar to the network(s) described herein). In some implementations of the present disclosure, the system 400 can be implemented. The application session can correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 400, for an application session, the client device(s) 404 can only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 can be displaying a frame of the application session on the display 424 based on receiving the display data from the application server(s) 402. The client device 404 can receive an input to one of the input device(s) and generate input data in response. The client device 404 can transmit the input data to the application server(s) 402 via the communication interface 420 and over the network(s) 406 (e.g., the Internet), and the application server(s) 402 can receive the input data via the communication interface 418. The CPU(s) can receive the input data, process the input data, and transmit data to the GPU(s) that causes the GPU(s) to generate a rendering of the application session. For example, the input data can be representative of a movement of a character of the user in a game session of a game application, firing a weapon, reloading, passing a ball, turning a vehicle, etc. The rendering component 412 can render the application session (e.g., representative of the result of the input data) and the render capture component 414 can capture the rendering of the application session as display data (e.g., as image data capturing the rendered frame of the application session). The rendering of the application session can include ray or path-traced lighting and/or shadow effects, computed using one or more parallel processing units—such as GPUs, which can further employ the use of one or more dedicated hardware accelerators or processing cores to perform ray or path-tracing techniques—of the application server(s) 402. In some implementations, one or more virtual machines (VMs)—e.g., including one or more virtual components, such as vGPUs, vCPUs, etc.—can be used by the application server(s) 402 to support the application sessions. The encoder 416 can then encode the display data to generate encoded display data and the encoded display data can be transmitted to the client device 404 over the network(s) 406 via the communication interface 418. The client device 404 can receive the encoded display data via the communication interface 420 and the decoder 422 can decode the encoded display data to generate the display data. The client device 404 can then display the display data via the display 424.

The systems and methods described herein can be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed implementations can be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Language Models

In at least some implementations, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in implementations, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in implementations, whereas in other implementations, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various implementations. For example, different architectures may be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) may be used, while in other implementations transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular implementation and the task(s) being performed using the LLMs/SLMs/VLMs/MMLMs/etc.

In various implementations, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure may be implemented using various model alignment techniques. For example, in some implementations, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some implementations, the LLMs/SLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data may be provided with the same input query and prompt (e.g., set of constraints, conditioners, etc.). In one or more implementations, the language models may be different versions of the same foundation model. In one or more implementations, at least one language model may be instantiated as multiple agents—e.g., more than one prompt may be provided to constrain, direct, or otherwise influence a style, a content, or a character, etc., of the output provided. In one or more example, non-limiting implementations, the same language model may be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more implementations, the output from one language model—or version, instance, or agent—maybe be provided as input to another language model for further processing and/or validation. In one or more implementations, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more implementations, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

### Example Computing Device

FIG. 5 is a block diagram of an example computing device(s) 500 suitable for use in implementing some implementations of the present disclosure. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 can comprise one or more virtual machines (VMs), and/or any of the components thereof can comprise virtual components (e.g., virtual hardware components). For non-limiting examples, one or more of the GPUs 508 can comprise one or more vGPUs, one or more of the CPUs 506 can comprise one or more vCPUs, and/or one or more of the logic units 520 can comprise one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In implementations, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In implementations, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that enable the computing device 500 to communicate with other computing devices via an electronic communication network, included wired and/or wireless communications. The communication interface 510 can include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 can include one or more data processing units (DPUs) to transmit data received over a network and/or through interconnect system 502 directly to (e.g., a memory of) one or more GPU(s) 508.

The I/O ports 512 can enable the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that enable detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to enable the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one implementations of the present disclosure. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one implementation, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) can correspond to a server having one or more of the above-mentioned computing resources. In addition, in some implementations, the node C.R.s 616(1)-616(N) can include one or more virtual components, such as vGPUs, vCPUs, and/or the like, and/or one or more of the node C.R.s 616(1)-616(N) can correspond to a virtual machine (VM).

In at least one implementation, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory or storage resources that can be configured or allocated to support one or more workloads. In at least one implementation, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one implementation, resource orchestrator 612 can include a software design infrastructure (SDI) management entity for the data center 600. The resource orchestrator 612 can include hardware, software, or some combination thereof.

In at least one implementation, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache SparkTM (hereinafter “Spark”) that can utilize distributed file system 638 for large-scale data processing (e.g., “big data”). In at least one implementation, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one implementation, clustered or grouped computing resources can include grouped computing resource 614 at data center infrastructure layer 610. The resource manager 636 can coordinate with resource orchestrator 612 to manage these mapped or allocated computing resources.

In at least one implementation, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one implementation, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 600. In at least one implementation, trained or deployed machine learning models corresponding to one or more neural networks can be used to infer or predict information using resources described above with respect to the data center 600 by using weight parameters calculated through one or more training techniques, such as but not limited to those described herein.

In at least one implementation, the data center 600 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server may not be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

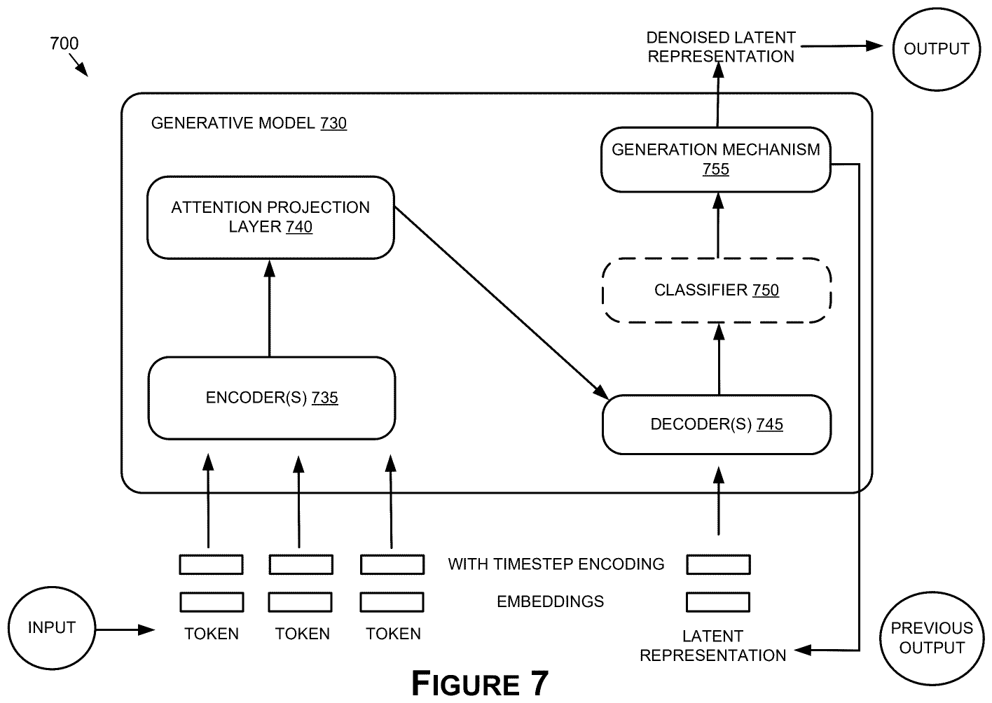

FIG. 7 is a block diagram of an example implementation in which a generative model 730 includes a transformer-based encoder-decoder architecture for use in a diffusion process. For example, assume an input image frame is encoded (e.g., by the embedding component 120 of FIG. 1) into a corresponding embedding (e.g., of size 512). The techniques described herein may be used to add a temporal encoding and/or timestep encoding to each embedding to represent temporal relationships between frames and progression through the denoising schedule. As such, the resulting embeddings may be applied to one or more encoder(s) 735 of the generative model 730 as part of the diffusion model's iterative denoising process.

In an example implementation, the encoder(s) 735 form an encoder stack, where each encoder includes a self-attention layer and a feedforward network. In an example transformer architecture for image processing, each token embedding flows through a separate path. Accordingly, each encoder may accept a sequence of embedding vectors, passing each vector through the self-attention layer, then through the feedforward network, and then to the next encoder in the stack. Any suitable self-attention technique may be used. For example, to compute self-attention for each token, a query vector, a key vector, and a value vector may be generated from the token embeddings; attention scores may be computed by taking the dot product of the query vector with the corresponding key vectors, normalizing the resulting scores, multiplying by the value vectors, and summing the weighted value vectors. The encoder may apply multi-head self-attention in which the attention operation is executed in parallel across multiple learned projections. Any number of encoders may be stacked to generate a context vector encoding the input. An attention projection layer 740 may convert the context vector into attention vectors (e.g., keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder 735 to focus on relevant parts of the input, and a feedforward network. As with the encoder(s) 735, in an example transformer architecture, each token embedding flows through a separate path in the decoder(s) 145. During each step of the iterative denoising process, the decoder(s) 745 may receive a noisy latent representation corresponding to the input frame at a particular timestep of the diffusion schedule. The decoder(s) 745 may use self-attention to model intra-frame dependencies and encoder-decoder attention to incorporate contextual information from the encoder(s) 735. The decoder(s) 745 may then output a denoised latent representation. This denoised representation may be passed to the generation mechanism 755, which may update the latent representation based on the predicted noise or directly predict the clean data sample, depending on the diffusion model formulation. The process may repeat for a predetermined number of steps (or until a convergence threshold is met), refining the latent representation iteratively at each step. The decoder may optionally incorporate timestep embeddings and/or spatial positional encodings during each denoising step.

As such, the decoder(s) 745 may output an updated latent representation of the image being processed at each denoising step. The generation mechanism 755 may apply the output to compute the next state in the denoising sequence, gradually reducing noise across timesteps until the final clean output image is produced. The classifier 750 may optionally be used to perform auxiliary tasks (e.g., classification of image content or timestep prediction) and may include one or more neural network layers to project the decoded representation into a target dimensionality. In some implementations, the generation mechanism 755 may implement a diffusion sampling procedure to traverse the reverse process through latent space from an initial noisy input toward a final denoised output.

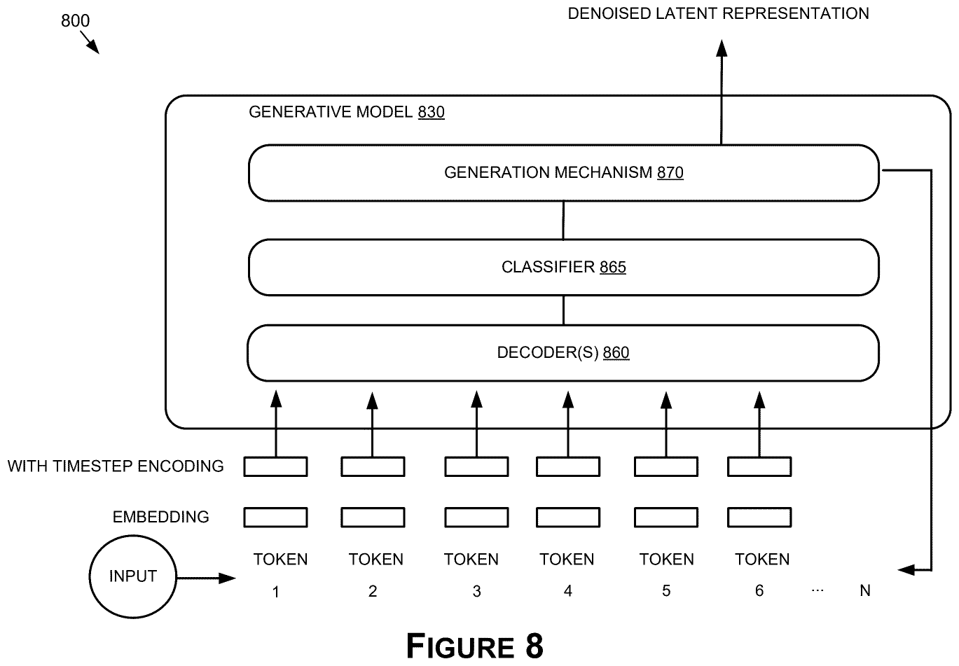

FIG. 8 is a block diagram of an example implementation in which the generative model 130 includes a decoder-only transformer architecture for use in a diffusion-based image processing system. For example, the decoder(s) 160 of FIG. 8 may operate similarly to the decoder(s) 745 of FIG. 7, except that each decoder 860 of FIG. 8 omits the encoder-decoder self-attention layer, as no separate encoder is used in this architecture. As such, the decoder(s) 860 may form a decoder stack, where each decoder includes a self-attention layer and a feedforward network. Rather than processing an input sequence of discrete tokens, the decoder(s) 860 may receive a latent representation of a noisy image frame at a given timestep of a diffusion schedule. A timestep encoding and/or spatial positional encoding may be applied to the latent representation prior to being input to the decoder(s) 860.

As with the decoder(s) 745 of FIG. 7, each embedding (e.g., corresponding to an image patch or spatial region) may flow through a separate path in the decoder(s) 860. The decoder(s) 860, in combination with a classifier 865 and a generation mechanism 870, may participate in an iterative denoising process, progressively refining the latent image representation at each diffusion step. At each step, the decoder(s) 860 may output an updated latent representation or a predicted noise component, which the generation mechanism 870 may apply to compute the latent state for the next timestep. This process may repeat for a predefined number of timesteps, gradually transforming the initial noise into a fully denoised image.

The classifier 865 and the generation mechanism 870 may operate similarly to the classifier 750 and generation mechanism 755 of FIG. 7. For example, the classifier 865 may optionally project the decoded latent representation into a lower-dimensional space for auxiliary predictions, such as class labels or denoising confidence scores. The generation mechanism 870 may apply the output of the decoder(s) 860 to estimate the clean image at the current step or predict the noise to be removed, depending on the model configuration. These and other architectures described herein are merely illustrative, and other suitable transformer-based or hybrid architectures may be implemented within the scope of the present disclosure.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
apply a first frame as input to a machine learning model to retrieve, from the machine learning model, a first embedding of the first frame;
store the first embedding in a cache, wherein the cache includes a second embedding of a second frame;
generate a third frame using the machine learning model based at least on the cache, wherein the third frame is associated with the first frame; and
output the third frame to a video stream comprising a fourth frame.

2. The one or more processors of claim 1, wherein the processing circuitry is to:
store the first embedding in a first slot in the cache; and
store the second embedding in a second slot in the cache.

3. The one or more processors of claim 1, wherein the first frame and the second frame are separated by an interval.

4. The one or more processors of claim 1, wherein the processing circuitry is to:
interpolate a fifth frame based at least on the fourth frame and the third frame, wherein the fourth frame is previously generated; and
output the fifth frame to the video stream between the fourth frame and the third frame.

5. The one or more processors of claim 1 wherein the processing circuitry is to, responsive to determining that a number of stored embeddings exceeds a cache capacity, remove a third embedding from the cache according to a corresponding weight.

6. The one or more processors of claim 1, wherein the processing circuitry is to:
predict a fifth frame based at least on the third frame; and
store a third embedding of the fifth frame in the cache.

7. The one or more processors of claim 1, wherein the processing circuitry is to assign, to at least one of the first embedding or the second embedding, a weight determined according to a duration of the corresponding embedding in the cache.

8. The one or more processors of claim 1, wherein the fourth frame is associated with the second frame.

9. The one or more processors of claim 6, wherein the fifth frame is predicted using optical flow.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for performing operations using one or more large language models (LLMs);
a system for performing operations using one or more small language models (SLMs);
a system for performing operations using one or more vision language models (VLMs);
a system for performing operations using one multi-modal language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or a system implemented at least partially using cloud computing resources.

11. A method comprising:
applying a first frame as input to a machine learning model to retrieve, from the machine learning model, a first embedding of the first frame;
storing the first embedding in a first slot in a cache, wherein the cache includes a second embedding of a second frame in a second slot in the cache;
generating a third frame using the machine learning model based at least on the cache, wherein the third frame is associated with the first frame; and
outputting the generated third frame to a video stream comprising a generated fourth frame.

12. The method of claim 11, further comprising:
interpolating a fifth frame based at least on the generated fourth frame and the generated third frame; and
outputting the interpolated fifth frame to the video stream between the generated fourth frame and the generated third frame.

13. The method of claim 11, further comprising:
determining an optical flow between the third frame and a fifth frame, wherein the fifth frame includes raw image data;
predicting a sixth frame based at least on the optical flow; and
storing a third embedding of the sixth frame in the cache.

14. The method of claim 11, further comprising assigning a first weight to the first embedding, the first weight determined according to a corresponding duration of the first embedding in the cache.

15. The method of claim 11, wherein the first frame and the second frame are separated by an interval.

16. The method of claim 11, wherein the first embedding of the generated fourth frame is associated with a third embedding of the second frame.

17. The method of claim 11, further comprising extending a self-attention layer of the machine learning model based at least on the cache.

18. The method of claim 11, further comprising:
linearly decreasing a second weight of the second embedding based at least on storing the first embedding in the cache.

19. The method of claim 18, further comprising, responsive to determining that a number of stored embeddings exceeds a cache capacity, removing the second embedding from the cache, based at least on the second weight.

20. A system comprising one or more processors to:
apply a first frame as input to a machine learning model to retrieve, from the machine learning model, a first embedding of the first frame;
store the first embedding in a first slot in a cache, wherein the cache includes a second embedding of a second frame in a second slot in the cache;
generate a third frame using the machine learning model based at least on the cache, wherein the third frame is associated with the first frame; and
output the third frame to a video stream comprising a generated fourth frame.
